(19) United States
(12) Patent Application Publication
(10) Pub. No.: US 2026/0106221 A1
(43) Pub. Date: Apr. 16, 2026

(54) LITHIUM SECONDARY BATTERY WITH ENHANCED SAFETY

(71) Applicant: SOLVAY SPECIALTY POLYMERS ITALY S.P.A., Bollata(MILANO) (IT)

(72) Inventors: Han-Seong Kim, Seoul (KR); Hyun-Cheol LEE, Seoul (KR); Marco AVATANEO, Bollate (MI) (IT); Stefano MILLEFANTI, Bollate (MI) (IT); Valeriy KAPELYUSHKO, Spinetta Marengo (IT); Vito TORTELLI, Bollate (MI) (IT)

(21) Appl. No.: 19/120,709

(22) PCT Filed: Oct. 6, 2023
(86) PCT No.: PCT/EP2023/077668

§ 371 Date: Apr. 11, 2025

(30) Foreign Application Priority Data
Oct. 12, 2022 (EP) 22201112.4

(51) Int. Cl. H01M 10/0567; H01M 10/0525; H01M 10/0568; H01M 10/0569; H01M 50/105

(52) U.S. Cl. CPC H01M 10/0567; H01M 10/0525; H01M 10/0568; H01M 10/0569; H01M 50/105; H01M 2300/0037

(57) ABSTRACT

The present invention relates to a composition comprising a) at least one fluorinated acyclic carboxylic acid ester and b) at least one halogenated benzene, and to a lithium secondary battery comprising the composition in a liquid electrolyte. The present invention also relates to use of the composition in a liquid electrolyte for a lithium secondary battery.

### CROSS-REFERENCE TO RELATED APPLICATION

This application claims priority to a European patent application No. 22201112.4 filed on Oct. 12, 2022, the whole content of this application being incorporated herein by reference for all purposes.

### TECHNICAL FIELD

The present invention relates to a composition comprising a) at least one fluorinated acyclic carboxylic acid ester and b) at least one halogenated benzene, and to a lithium secondary battery comprising the composition according to the present invention in a liquid electrolyte. The present invention also relates to use of the composition in a liquid electrolyte for a secondary battery, in particular to improve safety performance, more particularly to improve penetration performance exhibiting a hazard level of 4 or less, preferably 2 or less, according to EUCAR (European Council for Automotive R&D).

### BACKGROUND OF THE INVENTION

Lithium-ion batteries have retained dominant position in the market of rechargeable energy storage devices for decades, thanks to their many benefits such as light-weight, reasonable energy density and good cycle life. Nonetheless, higher energy density have been continuously required pursuant to the development of high power applications such as electrical vehicles, hybrid electrical vehicles, grid energy storage, etc.

Organic carbonates have been conventionally used as liquid electrolytes for lithium secondary batteries, for instance acyclic carbonates, such as ethyl methyl carbonate, dimethyl carbonate or diethyl carbonate, and cyclic carbonates, such as ethylene carbonate or propylene carbonate. However, these organic carbonates relatively easily decompose at high voltages, e.g., above 4.35V. Typically, driving the electrodes to higher/extreme voltages or exposing the cells to higher temperatures accelerates undesired reactions between liquid electrolytes and highly reactive electrodes that may result in reduced cycle life and capacity reduction. In a worst case scenario, a thermal runaway may occur, which accompanies fire/flame, followed by cell rupture/explosion and eventually by cell disintegration. Notably, such safety concerns are mainly because of the use of organic carbonates having relatively low boiling point and high flammability.

Accordingly, various approaches have been made to overcome the limitations of commonly used liquid electrolytes based on the organic carbonates, i.e. to improve safety performance while maintaining the cycling performance.

Solvents based on hydrofluoroethers are advantageous in comparison to organic carbonates, because they have low GWP (Global warming potential) and low flammability, and are thus safe and easy to handle. As one of the diverse research efforts with such purposes, a liquid electrolyte comprising a certain hydrofluoroether having a high fluorination rate was reported in WO2015/078791A (Solvay Specialty Polymers Italy S.p.A) to exhibit favorable properties in terms of solubility, ionic conductivity, oxidative stability at high voltage and low flammability, etc. as well as broad working temperature range.

JP2010/192327A (Sony Corp.) discloses a nonaqueous electrolyte solution in which an electrolyte salt is dissolved in a nonaqueous solvent comprising a halogenated benzene and a halogenated (cyclic and/or acyclic) carbonate, which exhibits excellent cycle characteristics at low temperatures and improved charge/discharge efficiency at high temperatures.

US2011/0311879A1 (Sony Corp.) discloses a nonaqueous electrolyte comprising a solvent, an electrolyte salt, an aromatic compound, in particular benzene derivatives, and a polyoxometalate, in particular a heteropolyacid, which exhibits improved high-temperature cycle discharge capacity retention and high-temperature storage discharge capacity retention.

As the technology matures, while the requirements for the safety keep increasing, notably in electric vehicles, characterization testing that evaluates the response to abuse environments becomes more meaningful and necessary than simple “pass/fail” testing. This is because understanding the failure mechanism and root causes thereon is critical in improving the safety performance. Pass/fail testing does not provide quantitative measurements of cell responses, whereas the characterization testing evaluates the response to abuse environments, through which failure modes and abuse conditions can be identified.

Among several characterizations, the penetration safety has been recognized as an important evaluation parameter that various attempts for improving the penetration safety have been investigated. This is because in case of an accident, penetration of a battery pack may happen as a result of an impact to be applied from outside and subsequently the electrodes in a charged state physically come into contact with each other that if a high current flows in a short time, a thermal runaway may occur, i.e. temperature of the battery pack keeps increasing as a combustion heat is accumulated inside the cells and induces pyrolytic reactions, eventually resulting in ignition/explosion. Most importantly, the penetration safety is a critical issue that is directly related to the life of passengers using the transport devices. Accordingly, when the penetration safety is not secured, an application of a lithium secondary battery into the electric vehicles should be eventually limited, notably in view of the current industrial demand that the electric vehicles require higher capacity power supply, which is ever increasing.

EUCAR is the European Council for Automotive R&D of the major European passenger car and commercial vehicle manufacturers, and has major automotive manufacturers as its members, including BMW group, FIAT Chrysler Automobiles, Ford Europe, Honda R&D Europe, Hyundai Motor Europe, Renault Group, Toyota Motor Europe, Volkswagen Group and Volvo Group. EUCAR facilitates and coordinates pre-competitive R&D projects and its members participate in a wide range of collaborative European R&D programs. Automotive requirements widely differ per manufacturer due to a large variety of vehicle sizes and applications within the transportation sector and hence different requirements need to be considered in context of specific transportation applications. In particular, Hazard Level from 0 to 7, adopted and modified by EUCAR, provides detailed description and classification criteria/effect, commonly known as EUCAR hazard level as shown below Table 1.

TABLE 1

| Hazard | | |
|---|---|---|
| Level | Description | Classification Criteria & Effect |
| 0 | No effect | No effect. No loss of functionality. |
| 1 | Passive | No defect; no leakage; no venting, fire or |
| | protection | flame; no rupture; no explosion; no exothermic |
| | activated | reaction or thermal runaway. Cell reversibly |
| | | damaged. Repair of protection device needed. |
| 2 | Defect/ | No leakage; no venting, fire or flame; no |
| | Damage | rupture; no explosion; no exothermic reaction |
| | | or thermal runaway. Cell irreversibly damaged. |
| | | Repair needed. |
| 3 | Leakage | No venting, fire or flame; no rupture; no |
| | Δmass < 50% | explosion. Weight loss < 50% of electrolyte |
| | | weight (electrolyte = solvent + salt). |
| 4 | Venting | No fire or flame; no rupture; no explosion. |
| | Δmass ≥ 50% | Weight loss ≥ 50% of electrolyte weight |
| | | (electrolyte = solvent + salt). |
| 5 | Fire or Flame | No rupture; no explosion (i.e. no flying parts). |
| 6 | Rupture | No explosion, but flying parts of the active |
| | | mass. |
| 7 | Explosion | Explosion (i.e. disintegration of the cell). |

In this regard, EUCAR hazard level has been referred to by many automotive manufacturers, not limited to European players. For instance, Sandia National Laboratories, which is one of three National Nuclear Security Administration R&D laboratories in the United States and is operated for the Department of Energy by Sandia Corporation, refer to EUCAR hazard level in evaluating safety performance of the cells and provide the detailed test protocol of SAND 2005-3123. Notably, EUCAR hazard level enables to assess the level of danger associated with batteries in a more specified/objective manner. In this regard, most of the automotive companies require a hazard level of 4 or less as a minimum requirement, preferably a hazard level of 2 or less, which corresponds to the imperative demand not to have fire nor flame, even under serious accidental conditions.

In addition to EUCAR hazard level, there are several guidelines for safety evaluations of secondary lithium batteries, for instance UL1642 (Underwriters Laboratories Inc.), SBA G1101 (Japan Storage Battery Association), etc. with different criteria and evaluation conditions with various parameters.

For instance, U.S. Pat. No. 10,818,885B2 (SK Innovation) discloses an adhesive pad which includes a substrate layer and an adhesive layer formed on at least one surface of the substrate layer, and an exterior material in which the adhesive pad is adhered to at least one surface thereof through the adhesive layer. The adhesive pad contributes to the prevention of ignition or explosion by means of improving penetration safety. The penetration safety is evaluated in reference to SBA G1101.

There still exist however outstanding needs for a liquid electrolyte for a lithium secondary battery having improved safety performance, in particular penetration safety performance, while maintaining good cycling performance.

### SUMMARY OF THE INVENTION

A first object of the present invention is a composition comprising:
a) at least one fluorinated acyclic carboxylic acid ester represented by the formula (I)

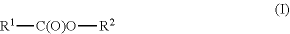

wherein R¹ is a C₁-C₄ alkyl group and R² is a C₁-C₄ fluoroalkyl group; and
b) at least one halogenated benzene represented by the formula (II)

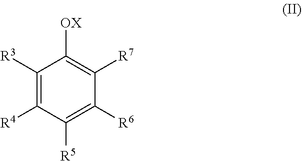

wherein X represents a C₁-C₄ fluoroalkyl group and each of R³ to R⁷ represents a hydrogen atom, a halogen atom, an alkyl group, a halogenated alkyl group, an alkoxy group, or a halogenated alkoxy group.

A second object of the invention is a lithium secondary battery comprising the composition according to the present invention in a liquid electrolyte.

A third object of the present invention is use of the composition in a liquid electrolyte for a lithium secondary battery.

It was surprisingly found by the inventors that the composition comprising a) at least one fluorinated acyclic carboxylic acid ester and b) at least one halogenated benzene according to the present invention may deliver a particularly advantageous combination of properties, i.e. good cycling performance and excellent safety performance, particularly penetration performance, when used in a liquid electrolyte for a secondary battery.

### DETAILED DESCRIPTION OF THE INVENTION

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. In the context of the present invention, the term ‘percent by weight’ (wt %) indicates the content of a specific component in a mixture, calculated as the ratio between the weight of the component and the total weight of the mixture, and the term ‘percent by volume’ (vol %) indicates the content of a specific component in a mixture, calculated as the ratio between the volume of the component and the total volume of the mixture.

It is to be understood that both the foregoing general description and the following detailed description are exemplary and are intended to provide further explanation of the invention as claimed. Accordingly, various changes and modifications described herein will be apparent to those skilled in the art. Moreover, descriptions of well-known functions and constructions may be omitted for clarity and conciseness.

The present invention provides a composition comprising:
a) at least one fluorinated acyclic carboxylic acid ester represented by the formula (I)

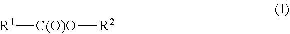

wherein R¹ is a C₁-C₄ alkyl group and R² is a C₁-C₄ fluoroalkyl group; and
b) at least one halogenated benzene represented by the formula (II)

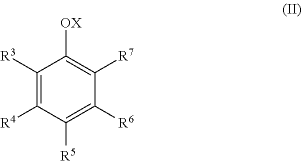

wherein X represents a C₁-C₄ fluoroalkyl group and each of R³ to R⁷ represents a hydrogen atom, a halogen atom, an alkyl group, a halogenated alkyl group, an alkoxy group, or a halogenated alkoxy group.

In one embodiment, R² contains neither a CH₂F— group nor a —CHF— group.

In a preferred embodiment, the number of carbon atom in R¹ in the formula (I) is 1.

In another preferred embodiment, the number of carbon atom in R¹ in the formula (I) is 2.

Non-limitative examples of suitable fluorinated acyclic carboxylic acid ester according to the present invention include, notably, the followings: CH₃—C(O)O—CH₂CF₂H, CH₃—C(O)O—CF₂CF₃, CH₃—C(O)O—CH₂CF₃, CH₃—C(O)O—CF₂CF₂CF₃, (CH₃)₂CH—C(O)O—CF₃, CH₃CH₂—C(O)O—CF₂H, CH₃CH₂—C(O)O—CF₂CH₃, CH₃—C(O)O—CH(CF₃)CH₃, CH₃CH₂—C(O)O—CH₂CF₂H, CH₃—C(O)O—CH₂CH₂CF₂H, CH₃—C(O)O—CH₂CF₂CF₂H, CH₃CH₂—C(O)O—CH₂CH₂CF₂H, CH₃CH₂—C(O)O—CH₂CH₂CF₂H, CH₃—C(O)O—CF₂CF₂H, CH₃—C(O)O—CF₂CF₂CF₂CF₂H, CH₃CH₂—C(O)O—CH₂CF₂H, CH₃CH₂CH₂—C(O)O—CH₂CF₃, CH₃—C(O)O—CH₂CH₂CF₂CF₃, (CH₃)₂CH—C(O)O—CH₂CF₂H, CH₃CH₂CH₂—C(O)O—CF₂H, (CH₃)₂CH—C(O)O—CF₂H, CH₃—C(O)O—CH₂CF₂H, CH₃—C(O)O—CH₂CF₃, CH₃CH₂—C(O)O—CH₂CH₂CF₃, CH₃CH₂—C(O)O—CH₂CF₃, and combinations thereof.

In a particular embodiment, a) the fluorinated acyclic carboxylic acid ester is selected from the group consisting of CH₃—C(O)O—CH₂CF₂H, CH₃—C(O)O—CF₂CF₂H, CH₃—C(O)O—CH₂CF₃, CH₃—C(O)O—CH₂CH₂CF₂H, CH₃—C(O)O—CH₂CF₂CF₂H, CH₃—C(O)O—CH₂CH₂CF₂CF₃, CH₃CH₂—C(O)O—CH₂CF₂H, CH₃CH₂—C(O)O—CH₂CF₃, CH₃CH₂—C(O)O—CH₂CH₂CF₂H, CH₃CH₂—C(O)O—CH₂CH₂CF₃, and combinations thereof.

In a more particular embodiment, a) the fluorinated acyclic carboxylic acid ester is CH₃—C(O)O—CH₂CF₂H (2,2-difluoroethyl acetate).

In one embodiment, one of R³ to R⁷ is a halogenated C₁-C₄ alkoxy group, preferably a C₁-C₂ fluoroalkoxy.

In another embodiment, at least one of R³ to R⁷ is a halogen atom.

In a particular embodiment, b) the halogenated benzene is selected from the group consisting of 1,1,2,2-tetrafluoroethoxy benzene, 1,1,2,2,2-pentafluoroethoxy benzene, fluoromethoxy benzene, difluoromethoxy benzene, trifluoromethoxy benzene, 1,2-bis(1,1,2,2-tetrafluoroethoxy) benzene, 1,3-bis(1,1,2,2-tetrafluoroethoxy) benzene, 1,4-bis(1,1,2,2-tetrafluoroethoxy) benzene, 4-trifluoromethoxy toluene, 1-fluoro-4-(1,1,2,2-tetrafluoroethoxy) benzene, 1-chloro-4-(1,1,2,2-tetrafluoroethoxy) benzene, 1-bromo-4-(1,1,2,2-tetrafluoroethoxy) benzene, and combinations thereof.

In a more particular embodiment, b) the halogenated benzene is 1,1,2,2-tetrafluoroethoxy benzene.

In another more particular embodiment, b) the halogenated benzene is 1-fluoro-4-(1,1,2,2-tetrafluoroethoxy) benzene.

In the other more particular embodiment, b) the halogenated benzene is 1,4-bis(1,1,2,2-tetrafluoroethoxy) benzene.

In one embodiment, the liquid electrolyte further comprises c) at least one organic carbonate, which may be partially or fully fluorinated. In the present invention, c) the organic carbonate may be either cyclic or acyclic.

Non-limiting examples of c) the organic carbonate include, notably, 4-fluoroethylene carbonate, 4,5-difluoro-1,3-dioxolan-2-one, 4,5-difluoro-4-methyl-1,3-dioxolan-2-one, 4,5-difluoro-4,5-dimethyl-1,3-dioxolan-2-one, 4,4-difluoro-1,3-dioxolan-2-one, 4,4,5-trifluoro-1,3-dioxolan-2-one, 4-fluoromethyl-1,3-dioxolan-2-one, tetrafluoroethylene carbonate, 4-(2,2-difluoroethoxy)ethylene carbonate, 4-(2,2,2-trifluoroethyoxy)ethylene carbonate, ethylene carbonate (1,3-dioxolan-2-one), propylene carbonate, butylene carbonate, trimethylene carbonate, vinylene carbonate, vinyl ethylene carbonate, dimethylvinylene carbonate, ethyl propyl carbonate, cyclohexene carbonate, dimethyl carbonate, ethyl methyl carbonate, diethyl carbonate, methyl-2,2-difluoroethyl carbonate, methyl-2,2,2-trifluoroethyl carbonate, methyl-2,2,3,3-tetrafluoropropyl carbonate, ethyl-2,2-difluoroethyl carbonate, ethyl-2,2,2-trifluoroethyl carbonate, or combinations thereof.

In a particular embodiment, c) the organic carbonate is a mixture of ethylene carbonate and ethyl methyl carbonate.

In another particular embodiment, c) the organic carbonate is a mixture of ethylene carbonate, ethyl methyl carbonate, and vinylene carbonate.

In another embodiment, the liquid electrolyte further comprises d) at least one lithium salt.

Non-limitative examples of d) the lithium salt according to the present invention include, notably, a lithium ion complex such as lithium hexafluorophosphate (LiPF₆), lithium perchlorate (LiClO₄), lithium hexafluoroarsenate (LiAsF₆), lithium hexafluoroantimonate (LiSbF₆), lithium hexafluorotantalate (LiTaF₆), lithium tetrachloroaluminate (LiAlCl₄), lithium tetrafluoroborate (LiBF₄), lithium chloroborate (Li₂B₁₀Cl₁₀), lithium fluoroborate (Li₂B₁₀F₁₀), Li₂B₁₂FₓH₁₂₋ₓ wherein x=0-12, LiPFₓ(R_{F})₆₋ₓ and LiBF_{y}(R_{F})_{4-y} wherein R_{F} represents perfluorinated C₁-C₂₀ alkyl groups or perfluorinated aromatic groups, x=0-5 and y=0-3, lithium bis(oxalato)borate [LiB(C₂O₄)₂], lithium bis(malonato)borate [LiB(O₂CCH₂CO₂)₂], lithium bis(difluoromalonato) borate [LiB(O₂CCF₂CO₂)₂], lithium difluorooxalato borate, and lithium fluoromalonato (difluoro)borate, LiPF₂[O₂C(CX₂)ₙCO₂]₂, LiPF₄[O₂C(CX₂)ₙCO₂] wherein X is selected from the group consisting of H, F, Cl, C₁-C₄ alkyl groups and fluorinated alkyl groups, and n=0-4, lithium trifluoromethane sulfonate (LiCF₃SO₃), lithium bis(fluorosulfonyl)imide Li(FSO₂)₂N (LiFSI), LiN(SO₂CₘF₂ₘ₊₁)(SO₂CₙF₂ₙ₊₁) and LiC(SO₂CₖF₂ₖ₊₁)(SO₂CₘF₂ₘ₊₁)(SO₂CₙF₂ₙ₊₁) wherein k=1-10, m=1-10 and n=1-10, LiN(SO₂CₚF₂ₚSO₂) and LiC(SO₂CₚF₂ₚSO₂)(SO₂C_{q}F_{2q+1}) wherein p=1-10 and q=1-10, or combinations thereof.

In one embodiment, d) the lithium salt according to the present invention is selected from the group consisting of lithium hexafluorophosphate (LiPF₆), lithium perchlorate (LiClO₄), lithium hexafluoroarsenate (LiAsF₆), lithium hexafluoroantimonate (LiSbF₆), lithium hexafluorotantalate (LiTaF₆), lithium tetrachloroaluminate (LiAlCl₄), lithium tetrafluoroborate (LiBF₄), lithium chloroborate (Li₂B₁₀Cl₁₀), lithium fluoroborate (Li₂B₁₀F₁₀), Li₂B₁₂FₓH₁₂₋ₓ wherein x=0-12, LiPFₓ(R_{F})₆₋ₓ and LiBF_{y}(R_{F})_{4-y} wherein R_{F} represents perfluorinated C₁-C₂₀ alkyl groups or perfluorinated aromatic groups, x=0-5 and y=0-3, lithium bis(oxalato)borate [LiB(C₂O₄)₂], lithium trifluoromethane sulfonate (LiCF₃SO₃), lithium bis(fluorosulfonyl)imide Li(FSO₂)₂N (LiFSI), LiN(SO₂CₘF₂ₘ₊₁)(SO₂CₙF₂ₙ₊₁) and LiC(SO₂CₖF₂ₖ₊₁)(SO₂CₘF₂ₘ₊₁)(SO₂CₙF₂ₙ₊₁) wherein k=1-10, m=1-10 and n=1-10, LiN(SO₂CₚF₂ₚSO₂) and LiC(SO₂CₚF₂ₚSO₂)(SO₂C_{q}F_{2q+1}) wherein p=1-10 and q=1-10, and combinations thereof.

In one particular embodiment, d) the lithium salt is lithium bis(trifluoromethanesulfonyl) imide (LiN(CF₃SO₂)₂) (LiTFSI).

In another particular embodiment, d) the lithium salt is LiFSI.

In the other particular embodiment, d) the lithium salt is LiPF₆.

According to one embodiment, the liquid electrolyte according to the present invention further comprises e) at least one film-forming additive, which promotes the formation of the solid electrolyte interface (SEI) layer on the surface of the electrodes by reacting in advance of the solvents on the surface of the electrodes. For the SEI layer, the main components hence comprise the decomposed products of liquid electrolytes and salts, which may include Li₂CO₃ (in case of LiCoO₂ as a cathode electro-active material), lithium alkyl carbonate, lithium alkyl oxide and other salt moieties such as LiF in case of LiPF₆-based electrolytes.

In one embodiment, e) the film-forming additive stabilizes the SEI layer at the surface of a positive electrode by preventing the structural change of the positive electrode, notably under high voltage.

This is because the reduction potential of e) the film-forming additive is higher than that of the liquid electrolyte when a reaction occurs at the surface of a negative electrode, and the oxidation potential of the film-forming additive is lower than that of the liquid electrolyte when the reaction occurs at the positive electrode.

In the present invention, e) the film-forming additive is different from d) the lithium salt.

In the present invention, e) the film-forming additive is different from c) the organic carbonate.

Non-limitative examples of e) the film-forming additive according to the present invention include, notably, cyclic sulfite and sulfate compounds comprising 1,3-propanesultone, ethylene sulfite and prop-1-ene-1,3-sultone; sulfone derivatives comprising dimethyl sulfone, tetramethylene sulfone (also known as sulfolane), ethyl methyl sulfone, and isopropyl methyl sulfone; nitrile derivatives comprising succinonitrile, adiponitrile, glutaronitrile, and 4,4,4-trifluoronitrile; lithium nitrate, vinyl acetate, biphenyl benzene, isopropyl benzene, tris(trimethylsilyl)phosphate, triphenyl phosphine, ethyl diphenyl phosphinite, triethyl phosphite, tris(2,2,2-trifluoroethyl) phosphite, maleic anhydride, cesium bis(trifluoromethanesulfonyl)imide, cesium fluoride, or combinations thereof.

In a particular embodiment, e) the film-forming additive according to the present invention is selected from the group consisting of 1,3,2-dioxathiolane-2,2-dioxide, 1,3,2-dioxathiane-2,2-dioxide, 1,3-propanesultone, ethylene sulfite, prop-1-ene-1,3-sultone, dimethyl sulfone, tetramethylene sulfone, ethyl methyl sulfone, isopropyl methyl sulfone, succinonitrile, adiponitrile, glutaronitrile, vinyl acetate, biphenyl benzene, isopropyl benzene, tris(trimethylsilyl)phosphate, triphenyl phosphine, ethyl diphenyl phosphinite, triethyl phosphite, tris(2,2,2-trifluoroethyl) phosphite, maleic anhydride, cesium bis(trifluoromethanesulfonyl)imide and cesium fluoride, and combinations thereof.

In one preferred embodiment, e) the film-forming additive is 1,3-propanesultone

According to another embodiment, e) the film-forming additive is an ionic liquid.

The term “ionic liquid” as used herein refers to a compound comprising a positively charged cation and a negatively charged anion, which is in the liquid state at the temperature of 100° C. or less under atmospheric pressure. While ordinary liquids such as water are predominantly made of electrically neutral molecules, ionic liquids are largely made of ions and short-lived ion pairs. As used herein, the term “ionic liquid” indicates a compound free from solvent.

In a preferred embodiment, the ionic liquid contains:
a positively charged cation selected from the group consisting of imidazolnium, pyridinium, pyrrolidinium and piperidinium ions optionally containing one or more C₁-C₃₀ alkyl groups, and
a negatively charged anion selected from the group consisting of halides, fluorinated anions, and borates.

Non-limiting examples of C₁-C₃₀ alkyl groups include, notably, methyl, ethyl, propyl, iso-propyl, n-butyl, isobutyl, sec-butyl, tert-butyl, pentyl, isopentyl, 2,2-dimethyl-propyl, hexyl, 2,3-dimethyl-2-butyl, heptyl, 2,2-dimethyl-3-pentyl, 2-methyl-2-hexyl, octyl, 4-methyl-3-heptyl, nonyl, decyl, undecyl, and dodecyl groups.

In one preferred embodiment, e) the film-forming additive according to the present invention is selected from the group consisting of N-methyl-N-propyl pyrrolidinium bis(fluorosulfonyl) imide (PYR13FSI), N-butyl-N-methyl pyrrolidinium bis(fluorosulfonyl) imide (PYR14FSI), N-methyl-N-propyl pyrrolidinium bis(trifluoromethanesulfonyl) imide (PYR13TFSI), and N-butyl-N-methylpyrrolidinium bis(trifluoromethanesulfonyl) imide (PYR14TFSI), and combinations thereof.

A second object of the present invention is a lithium secondary battery comprising the composition according to the present invention in a liquid electrolyte.

In one embodiment, a lithium secondary battery comprises a liquid electrolyte comprising the composition according to the present invention, a positive electrode, a negative electrode, and a separator that is positioned between the positive electrode and the negative electrode.

In the present invention, the term “separator” is intended to denote, in particular, an ionically permeable membrane placed between a positive electrode and a negative electrode. Its function is to be permeable to the lithium ions while blocking electrons and assuring the physical separation between the electrodes. That is, the separator refers to a monolayer or multilayer in a polymeric, nonwoven cellulose or ceramic material/film, which electrically and physically separates the electrodes having opposite polarities in an electrochemical device and is permeable to ions flowing between them.

An electrode in an electrochemical cell is referred to as either an anode or cathode. The anode is defined as the electrode where electrons leave the cell and oxidation occurs, and the cathode as the electrode where electrons enter the cell and reduction occurs. Each electrode may become either an anode or a cathode depending on the direction of electric current through a cell. A bipolar electrode is an electrode that functions as the anode of one cell and the cathode of another cell. When a cell is being charged, the anode becomes the positive electrode and the cathode becomes the negative electrode, while when a cell is being discharged, the anode becomes the negative electrode and the cathode becomes the positive electrode.

In the present invention, the term “negative electrode” is intended to denote, in particular, the electrode of an electrochemical cell, where oxidation occurs during discharging.

In the present invention, the term “positive electrode” is intended to denote, in particular, the electrode of an electrochemical cell, where reduction occurs during discharging.

In one embodiment, the content of a) the fluorinated acyclic carboxylic acid ester is at least 0.1 wt %, preferably at least 1.0 wt %, more preferably at least 2.0 wt % and/or at most 80.0 wt %, preferably at most 60.0 wt %, more preferably at most 10.0 wt %, relative to the total weight of the liquid electrolyte.

In a particular embodiment, the content of a) the fluorinated acyclic carboxylic acid ester is from 0.1 to 80.0 wt %, preferably 1.0 to 60.0 wt %, more preferably 2.0 to 10.0 wt %, relative to the total weight of the liquid electrolyte.

In a more particular embodiment, the content of a) the fluorinated acyclic carboxylic acid ester is from 2.0 to 3.5 wt %, relative to the total weight of the liquid electrolyte.

In one embodiment, the content of b) the halogenated benzene is at least 0.1 wt %, preferably at least 1.0 wt %, more preferably at least 2.0 wt %, and/or at most 20.0 wt %, preferably at most 10.0 wt %, more preferably at most 5.0 wt %, relative to the total weight of the liquid electrolyte.

In a particular embodiment, the content of b) the halogenated benzene is from 0.1 to 20.0 wt %, preferably 1.0 to 10.0 wt %, and more preferably 2.0 to 5.0 wt %, relative to the total weight of the liquid electrolyte.

In a more particular embodiment, the content of b) the halogenated benzene is from 2.0 to 3.5 wt %, relative to the total weight of the liquid electrolyte.

In the present invention, the total amount of c) the organic carbonate is from 0 to 95.0 wt %, preferably from 0 to 80.0 wt %, more preferably from 0 to 60.0 wt %, relative to the total weight of the liquid electrolyte.

The total amount of c) the organic carbonate, if contained in the liquid electrolyte of the present invention, is from 10.0 to 95.0 wt %, preferably from 20.0 to 80.0 wt %, relative to the total weight of the liquid electrolyte.

In one embodiment, a molar concentration (M) of d) the lithium salt in the liquid electrolyte according to the present invention is from 0.5 M to 8.0 M, preferably from 0.7 M to 3.0 M, and more preferably from 1.0 M to 2.0 M.

In the present invention, the total amount of e) the film-forming additive may be from 0 to 30.0 wt %, preferably from 0 to 20.0 wt %, more preferably from 0 to 15.0 wt %, and even more preferably from 0 to 5.0 wt %, relative to the total weight of the liquid electrolyte.

The total amount of e) the film-forming additive, if contained in the liquid electrolyte of the present invention, is from 0.05 to 10.0 wt %, preferably from 0.05 to 5.0 wt %, and more preferably from 0.05 to 2.0 wt %, relative to the total weight of the liquid electrolyte.

In a preferred embodiment, the total amount of e) the film-forming additive accounts for at least 0.5 wt % of the liquid electrolyte.

A third object of the present invention relates to use of a composition according to the present invention in a liquid electrolyte for a lithium secondary battery.

In one embodiment, the composition comprising a) at least one fluorinated acyclic carboxylic acid ester and b) at least one halogenated benzene contributes to the improvement of safety performance, when used in a liquid electrolyte for a lithium secondary battery.

In a particular embodiment, the composition exhibits a hazard level of 4 or less, preferably 2 or less, according to EUCAR (European Council for Automotive R&D) hazard level.

In one embodiment, the total amount of a) the fluorinated acyclic carboxylic acid ester and b) the halogenated benzene is from 0.2 to 20.0 wt %, preferably from 2.0 to 15.0 wt %, more preferably from 3.0 to 10.0 wt %, most preferably from 4.0 to 7.0 wt %, relative to the total weight of the liquid electrolyte.

Should the disclosure of any patents, patent applications, and publications which are incorporated herein by reference conflict with the description of the present application to the extent that it may render a term unclear, the present description shall take precedence.

The invention will be now explained in more detail with reference to the following examples, whose purpose is merely illustrative and not intended to limit the scope of the invention.

### Examples

### Raw Materials

DFEA: a fluorinated acyclic carboxylic acid ester of CH₃—C(O)O—CH₂CF₂H, synthesized within Solvay
NP08: 1,1,2,2-tetrafluoroethoxy benzene, synthesized within Solvay
EC: ethylene carbonate, commercially available from Soulbrain
EMC: ethyl methyl carbonate, commercially available from Soulbrain
VC: vinylene carbonate, commercially available from Soulbrain
PS: 1,3-propanesultone, commercially available from Soulbrain
Li salt: lithium hexafluorophosphate (LiPF₆), commercially available from Soulbrain

### Formulation of the Liquid Electrolyte:

The reference liquid electrolyte (‘reference’ hereinafter) was prepared by adding a mixture of EC and EMC in 30:70 (in vol %) in a reactor, followed by introducing 2.0 wt % of VC and 0.5 wt % of PS into the mixture and by mixing under stirring for 16 hours until the solution became transparent. The wt % was relative to the total weight of the mixture. 1 M of LiPF₆ was then dissolved in the solution.

When preparing the liquid electrolyte for the Inventive Example (E1), a mixture of 3.0 wt % of NP08 and 2.0 wt % of DFEA, relative to the total weight of the liquid electrolyte, was further added to the reference, under stirring for 2 hours.

The reference was used as the liquid electrolyte for Comparative Example 1 (CE1).

The liquid electrolyte of Comparative Example 2 (CE2) was prepared in the same manner as E1, except that 5 wt % of NP08 (without DFEA) was added.

The liquid electrolyte of Comparative Example 3 (CE3) was prepared in the same manner as E1, except that 5 wt % of DFEA (without NP08) was added.

### Electrolyte Filling & 1^{st} Ageing

The liquid electrolytes as prepared were injected into the dry pouch cells (1500 mAh at 4.2 V) by pipetting. After injection, the dry cells were kept at a vacuum container for better wettability, sealed using a vacuum sealer, and then kept for additional 24 hours at room temperature (1^{st} ageing).

### Formation (2^{nd} Ageing/Activation of Electrochemical Cells)

The pouch cells were charged to 30% charging level (state of charge (SOC) 30%) after the 1^{st} ageing and then the cells were kept at room temperature for additional 24 hours (2^{nd} ageing).

### Degassing

Gases generated in the pouch cells during the formation were removed by opening the cells, followed by re-sealing.

### Electrochemical Cell Evaluation

The cells were evaluated under the test conditions as described below:
Cycle test at room temperature
   Charge: 1C/4.2V/0.05C (Constant current/Constant voltage)
   Discharge: 1C/3.0V (Constant current)
Nail penetration test (mechanical abuse test) was implemented according to SAND 2005-3123:
   Penetration with an isolated steel bar of 3 mm diameter with velocity of 8 cm/s at 4.35V (test voltage at SOC 100%).
   Minimum penetration depth: Cells must be penetrated completely.
   Hazard level: Outcome of nail penetration test was classified under the EUCAR hazard level from 0 to 7.

### Results

The initial discharge capacity, 90% capacity retention and nail penetration test results of E1 and CE1-CE3 are shown in Table 1 below. The cycling of E1 and CE1-CE3 is ongoing to estimate 80% capacity retention in cycles.

E1 showed good initial discharge capacity and 90% capacity retention, as well as excellent penetration performance. The hazard level 2 under EUCAR corresponds to that the cell is irreversibly damaged and needs to be repaired, but there's no leakage, no venting, no fire/flame, no exothermic reaction or thermal runaway, whereas fire/flame is accompanied with the hazard level 5.

Though CE1 and CE3 exhibited initial discharge capacity and 90% capacity retention comparable to those of E1, the nail penetration test of both CE1 and CE3 resulted in flame and fire (corresponding to the hazard level 5). Among comparative examples, CE2 only exhibited the hazard level 2. However, CE2 showed inferior 90% capacity retention and initial discharge capacity to those of E1.

Accordingly, it was clearly demonstrated that only E1 according to the present invention can exhibit excellent performances in both cycling and penetration safety.

TABLE 2

| | Initial discharge | 90% capacity | Nail penetration test |
|---|---|---|---|
| | capacity (mAh) | retention (cycles) | (hazard level) |
| E1 | 1446 | 765 | 2 |
| CE1 | 1454 | 785 | 5 |
| CE2 | 1428 | 706 | 2 |
| CE3 | 1446 | 755 | 5 |

1. A composition comprising:
a) at least one fluorinated acyclic carboxylic acid ester represented by the formula (I) 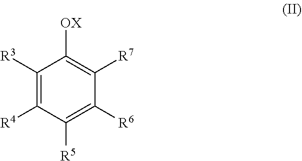
wherein R¹ is a C₁-C₄ alkyl group and R² is a C₁-C₄ fluoroalkyl group; and
b) at least one halogenated benzene represented by the formula (II) 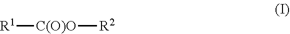
wherein X represents a C₁-C₄ fluoroalkyl group and each of R³ to R⁷ represents a hydrogen atom, a halogen atom, an alkyl group, a halogenated alkyl group, an alkoxy group, or a halogenated alkoxy group.

2. The composition according to claim 1, wherein R² contains neither a CH₂F— group nor a —CHF— group.

3. The composition according to claim 1, wherein a) the at least one fluorinated acyclic carboxylic acid ester is selected from the group consisting of CH₃—C(O)O—CH₂CF₂H, CH₃—C(O)O—CF₂CF₂H, CH₃—C(O)O—CH₂CF₃, CH₃—C(O)O—CH₂CH₂CF₂H, CH₃—C(O)O—CH₂CF₂CF₂H, CH₃—C(O)O—CH₂CH₂CF₂CF₃, CH₃CH₂—C(O)O—CH₂CF₂H, CH₃CH₂—C(O)O—CH₂CF₃, CH₃CH₂—C(O)O—CH₂CH₂CF₂H, CH₃CH₂—C(O)O—CH₂CH₂CF₃, and combinations thereof.

4. The composition according to claim 1, wherein b) the at least one halogenated benzene is selected from the group consisting of 1,1,2,2-tetrafluoroethoxy benzene, 1,1,2,2,2-pentafluoroethoxy benzene, fluoromethoxy benzene, difluoromethoxy benzene, trifluoromethoxy benzene, 1,2-bis(1,1,2,2-tetrafluoroethoxy) benzene, 1,3-bis(1,1,2,2-tetrafluoroethoxy) benzene, 1,4-bis(1,1,2,2-tetrafluoroethoxy) benzene, 4-trifluoromethoxy toluene, 1-fluoro-4-(1,1,2,2-tetrafluoroethoxy) benzene, 1-chloro-4-(1,1,2,2-tetrafluoroethoxy) benzene, 1-bromo-4-(1,1,2,2-tetrafluoroethoxy) benzene, and combinations thereof.

5. The composition according to claim 1, further comprising c) at least one organic carbonate.

6. The composition according to claim 5, wherein c) the at least one organic carbonate is selected from the group consisting of 4-fluoroethylene carbonate, 4,5-difluoro-1,3-dioxolan-2-one, 4,5-difluoro-4-methyl-1,3-dioxolan-2-one, 4,5-difluoro-4,5-dimethyl-1,3-dioxolan-2-one, 4,4-difluoro-1,3-dioxolan-2-one, 4,4,5-trifluoro-1,3-dioxolan-2-one, 4-fluoromethyl-1,3-dioxolan-2-one, tetrafluoroethylene carbonate, 4-(2,2-difluoroethoxy)ethylene carbonate, 4-(2,2,2-trifluoroethyoxy)ethylene carbonate, ethylene carbonate, propylene carbonate, butylene carbonate, trimethylene carbonate, vinylene carbonate, vinyl ethylene carbonate, dimethylvinylene carbonate, ethyl propyl carbonate, cyclohexene carbonate, dimethyl carbonate, ethyl methyl carbonate, diethyl carbonate, methyl-2,2-difluoroethyl carbonate, methyl-2,2,2-trifluoroethyl carbonate, methyl-2,2,3,3-tetrafluoropropyl carbonate, ethyl-2,2-difluoroethyl carbonate, ethyl-2,2,2-trifluoroethyl carbonate, and combinations thereof.

7. The composition according to claim 1, further comprising d) at least one lithium salt.

8. The composition according to claim 7, wherein d) the at least one lithium salt is selected from the group consisting of lithium hexafluorophosphate (LiPF₆), lithium perchlorate (LiClO₄), lithium hexafluoroarsenate (LiAsF₆), lithium hexafluoroantimonate (LiSbF₆), lithium hexafluorotantalate (LiTaF₆), lithium tetrachloroaluminate (LiAlCl₄), lithium tetrafluoroborate (LiBF₄), lithium chloroborate (Li₂B₁₀Cl₁₀), lithium fluoroborate (Li₂B₁₀F₁₀), Li₂B₁₂FₓH₁₂₋ₓ wherein x=0-12, LiPFₓ(R_{F})₆₋ₓ and LiBF_{y}(R_{F})_{4-y} wherein R_{F} represents perfluorinated C₁-C₂₀ alkyl groups or perfluorinated aromatic groups, x=0-5 and y=0-3, lithium bis(oxalato)borate [LiB(C₂O₄)₂], LiBF₂[O₂C(CX₂)ₙCO₂], LiPF₂[O₂C(CX₂)ₙCO₂]₂, and LiPF₄[O₂C(CX₂)ₙCO₂] wherein X is selected from the group consisting of H, F, Cl, C₁-C₄ alkyl groups and fluorinated alkyl groups, and n=0-4, lithium trifluoromethane sulfonate (LiCF₃SO₃), lithium bis(fluorosulfonyl)imide Li(FSO₂)₂N (LiFSI), LiN(SO₂CₘF₂ₘ₊₁)(SO₂CₙF₂ₙ₊₁) and LiC(SO₂CₖF₂ₖ₊₁)(SO₂CₘF₂ₘ₊₁)(SO₂CₙF₂ₙ₊₁) wherein k=1-10, m=1-10 and n=1-10, LiN(SO₂CₚF₂ₚSO₂) and LiC(SO₂CₚF₂ₚSO₂)(SO₂C_{q}F_{2q+1}) wherein p=1-10 and q=1-10, and combinations thereof.

9. The composition according to claim 1, further comprising e) at least one film-forming additive.

10. The composition according to claim 9, wherein e) the at least one film-forming additive is selected from the group consisting of 1,3,2-dioxathiolane-2,2-dioxide, 1,3,2-dioxathiane-2,2-dioxide, 1,3-propanesultone, ethylene sulphite, prop-1-ene-1,3-sultone, dimethyl sulfone, tetramethylene sulfone (also known as sulfolane), ethyl methyl sulfone, isopropyl methyl sulfone, succinonitrile, adiponitrile, glutaronitirle, vinyl acetate, biphenyl benzene, isopropyl benzene, tris(trimethylsilyl)phosphate, triphenyl phosphine, ethyl diphenylphosphinite, triethyl phosphite, tris(2,2,2-trifluoroethyl) phosphite, maleic anhydride, cesium bis(trifluoromethanesulfonyl)imide, cesium fluoride, and combinations thereof.

11. A lithium secondary battery comprising a composition according to claim 1 in a liquid electrolyte.

12. The lithium secondary battery according to claim 11, wherein the content of a) the fluorinated acyclic carboxylic acid ester is at least 0.1 to 80.0% by weight (wt %), relative to the total weight of the liquid electrolyte.

13. The lithium secondary battery according to claim 11, wherein the content of b) the halogenated benzene is from 0.1 to 20.0 wt %, relative to the total weight of the liquid electrolyte.

14. A method comprising including a liquid electrolyte in a lithium secondary battery, wherein the liquid electrolyte comprises the composition according to claim 1.

15. The method according to claim 14, wherein the total amount of a) the fluorinated acyclic carboxylic acid ester and b) the halogenated benzene is from 0.2 to 20.0 wt %, relative to the total weight of the liquid electrolyte.
